(19) United States
(12) Patent Application Publication
(10) Pub. No.: US 2026/0188244 A1
(43) Pub. Date: Jul. 2, 2026

(54) GATE DRIVER AND DISPLAY DEVICE INCLUDING THE SAME

(71) Applicant: LG Display Co., Ltd., Seoul (KR)

(72) Inventor: Jisoo Yu, Paju-si (KR)

(73) Assignee: LG Display Co., Ltd., Seoul (KR)

(21) Appl. No.: 19/313,579

(22) Filed: Aug. 28, 2025

(30) Foreign Application Priority Data
Dec. 31, 2024 (KR) 10-2024-0203044

(51) Int. Cl. G09G 3/3266

(52) U.S. Cl. CPC G09G 3/3266; G09G 2300/043; G09G 2310/0286; G09G 2330/021

(57) ABSTRACT

A gate driver includes a plurality of stages, wherein each stage includes: an input circuit configured to operate based on one clock signal to input a gate low voltage or a gate high voltage to a Q1 node; a Q-node control circuit configured to operate based on the gate low voltage to apply the gate low voltage of the Q1 node to a Q node; a QB-node control circuit configured to operate based on the gate high voltage of the Q1 node to apply the gate high voltage to a QB node; and an output circuit configured to output the gate low voltage of the Q node or the gate high voltage of the QB node to an output terminal, wherein the Q-node control circuit includes: a first switching transistor; and a second switching transistor for lowering a voltage between gate and source electrodes of the first switching transistor.

### CROSS REFERENCE TO RELATED APPLICATION

The present application claims priority to Korean Patent Application No. 10-2024-0203044, filed on Dec. 31, 2024, the entire contents of which is incorporated herein for all purposes by this reference.

### BACKGROUND

### Field

The present disclosure relates to a gate driver and a display device including the same and, more particularly, to a gate driver capable of reducing stress by adding a switching transistor to a stage of the gate driver, and a display device including the same.

### Description of Related Art

Display devices used in a computer monitor, a TV, a mobile phone, or the like include an organic light-emitting display (OLED) that emits light by itself, and a liquid crystal display (LCD) that requires a separate light source.

Among these various display devices, the organic light-emitting display device includes a display panel including a plurality of sub-pixels and a driver for driving the display panel. The driver includes a gate driver for supplying a gate signal to the display panel and a data driver for supplying a data voltage thereto. In addition, when a signal such as the gate signal and the data voltage is supplied to the sub-pixel of the organic light-emitting display device, the selected sub-pixel may emit light to display an image.

The display device may include pixels. Each pixel may include a plurality of sub-pixels. Each sub-pixel has a light-emitting element and a pixel circuit for driving the light-emitting element.

In addition, the gate driver may include a plurality of stages selectively connected to lines to which a plurality of clock signals are supplied so as to sequentially output a scan signal. In addition, the pixel circuit includes a driving transistor for controlling a driving current flowing through the light-emitting element, and at least one switching transistor for controlling (or programming) a gate-source voltage of the driving transistor according to the gate signal (scan signal).

However, as the scan signal of a high voltage output from the stage is continuously applied to the gate electrode of the switching transistor of the pixel circuit, a threshold voltage thereof is gradually shifted, and as a result, the switching transistor is vulnerable to a positive bias temperature stress (PBTS), and a reliable margin is not secured.

Therefore, there is a need to lower a voltage of the scan signal output from the stage to reduce the PBTS of the switching transistor and to secure the reliable margin.

### SUMMARY

Conventionally, as the scan signal of the high voltage output from the stage is continuously applied to the gate electrode of the switching transistor of the pixel circuit, the threshold voltage is gradually shifted, and as a result, the switching transistor is vulnerable to PBTS and a reliable margin is not secured.

Accordingly, the inventor of the present disclosure has invented a gate driver capable of reducing the PBTS applied to the switching transistor of the stage to secure a reliable margin, and a display device including the same.

A technical purpose of one or more embodiments of the present disclosure is to provide a gate driver for lowering a voltage of a scan signal applied to a pixel circuit to reduce power consumption, and a display device including the same.

Another technical purpose of one or more embodiments of the present disclosure is to provide a gate driver in which a further switching transistor is additionally disposed to lower a voltage between a gate electrode and a source electrode of a switching transistor included in a Q-node control circuit, and a display device including the same.

In addition, still another technical purpose of one or more embodiments of the present disclosure is to provide a gate driver configured such that a P-type switching transistor included in a Q-node control circuit is further connected to a N-type switching transistor included in the Q-node control circuit, and a display device including the same.

Purposes according to various embodiments of the present disclosure are not limited to the above-mentioned purposes. Other purposes and advantages according to the present disclosure that are not mentioned may be understood based on following descriptions, and may be more clearly understood based on example embodiments according to the present disclosure. Further, it can be easily understood from the descriptions provided herein that the purposes and advantages according to various embodiments of the present disclosure may be realized by practicing the example embodiments described herein, including in the claims or combinations thereof.

According to an example embodiment of the present disclosure, there is provided a gate driver configured such that a second switching transistor for lowering a voltage between a gate electrode and a source electrode of a first switching transistor included in a Q-node control circuit of a stage is additionally disposed in the stage.

In addition, according to an example embodiment of the present disclosure, a stage including different types of switching transistors is provided.

In addition, according to an example embodiment of the present disclosure, a gate driver for reducing power consumption by lowering a voltage of a scan signal applied to a pixel circuit, and a display device including the same are provided.

In addition, according to an example embodiment of the present disclosure, there are provided a gate driver configured such that a further switching transistor is additionally disposed to lower a voltage between a gate electrode and a source electrode of a switching transistor included in a Q-node control circuit, and a display device including the same.

The stage of the gate driver according to an example embodiment of the present disclosure may include the further switching transistor additionally disposing in the Q-node control circuit, thereby lowering the voltage between the gate electrode and the source electrode of the switching transistor and lowering the voltage of the scan signal supplied to the pixel circuit.

In addition, in the stage according to an example embodiment of the present disclosure, the P-type switching transistor is connected to the source electrode of the N-type first switching transistor, and the voltage between the gate electrode and the source electrode of the first switching transistor is lowered to a voltage obtained by subtracting the gate low voltage VGL and the threshold voltage Vth of the P-type switching transistor from the gate high voltage VGH, thereby securing the PBTS margin of the first switching transistor.

In addition, the voltage of the scan signal output from the stage according to an example embodiment of the present disclosure and transmitted to the pixel circuit is lowered, such that the PBTS applied to the switching transistor may be reduced, the reliable margin may be secured, and power consumption may be reduced.

Effects of the present disclosure are not limited to the effects mentioned above, and other effects not mentioned can be clearly understood by those skilled in the art from the description as set forth below.

In addition to the above effects, specific effects of the present disclosure are described together in, or may be understood from, the description of specific details for implementing the example embodiments of the present disclosure detailed below.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain the principles of the disclosure.

FIG. 1 is a plan view illustrating a display device according to an example embodiment of the present disclosure.

FIG. 2 is a cross-sectional view illustrating a cross-section taken along a line A-A′ in FIG. 1 in a display device according to an example embodiment of the present disclosure.

FIG. 3 is a diagram illustrating a configuration of a gate driver in a display device according to an example embodiment of the present disclosure.

FIG. 4 is a circuit diagram of any stage in a gate shift register of a gate driver according to an example embodiment of the present disclosure.

FIG. 5 is an example diagram illustrating a configuration of a pixel circuit of a display device according to an example embodiment of the present disclosure.

FIG. 6A is an example diagram illustrating a state in which a scan signal of a gate high voltage is output from a stage according to an example embodiment of the present disclosure.

FIG. 6B is an example diagram illustrating a state in which a scan signal of a gate low voltage is output from a stage according to an example embodiment of the present disclosure.

FIG. 7 is a circuit diagram of any stage in a gate shift register of a gate driver according to another example embodiment of the present disclosure.

FIG. 8 is a configuration circuit diagram of any stage in a gate shift register of a gate driver according to still another example embodiment of the present disclosure.

### DETAILED DESCRIPTION

Advantages and features of the present disclosure, and a method of achieving the advantages and features will become apparent with reference to example embodiments described below in detail together with the accompanying drawings. However, the present disclosure is not limited to the example embodiments as disclosed below but may be implemented in various other forms. Thus, these embodiments are set forth only to make the present disclosure more complete, and to more fully inform the scope of the present disclosure to those of ordinary skill in the technical field to which the present disclosure belongs. and the protective scope of the present disclosure may be defined by the scope of the claims and their equivalents.

For simplicity and clarity of illustration, elements in the drawings are not necessarily drawn to scale. The same reference numbers in different drawings represent the same or similar elements, and as such perform similar functionality, unless otherwise specified. Further, descriptions and details of well-known steps and elements may be omitted for simplicity of the description. Furthermore, in the following detailed description of example embodiments of the present disclosure, numerous specific details may be set forth to provide a thorough understanding of the present disclosure. However, it should be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It should be understood that the description herein is not intended to limit the claims to the specific embodiments described. On the contrary, it is intended to cover alternatives, modifications, and equivalents as may be included within the spirit and scope of the present disclosure as defined by the appended claims and their equivalents.

A shape, a size, a ratio, an angle, a number, etc. disclosed in the drawings for illustrating example embodiments of the present disclosure are illustrative, and the present disclosure is not limited thereto. The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It should be further understood that the terms “comprise”, “comprising”, “include”, and “including,” where used in this disclosure, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expressions like “at least one of,” where preceding a list of elements, may modify the entire list of elements and may not modify the individual elements of the list. In interpretation of numerical values, an error or tolerance therein may occur even where there is no explicit description thereof.

In descriptions of temporal relationships, for example, temporal precedent relationships between two events such as “after”, “subsequent to”, “before”, etc., another event may occur therebetween unless a more limiting phrase like “directly after”, “directly subsequent” or “directly before” is indicated. Where a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It should be understood that, although the terms “first”, “second”, “third”, and so on may be used herein to describe various elements, components, areas, layers and/or periods, these elements, components, areas, layers and/or periods should not be limited by these terms. These terms are used to refer to one element, component, area, layer or period separately from another element, component, area, layer or period. Thus, a first element, component, area, layer or period as described under could be termed a second element, component, area, layer or period, and vice versa, without departing from the spirit and scope of the present disclosure.

Where an embodiment may be implemented differently, functions or operations specified within a specific block may be performed in a different order from an order specified in a flowchart. For example, two consecutive blocks may actually be performed substantially simultaneously, or the blocks may be performed in a reverse order depending on related functions or operations. The features of the various embodiments of the present disclosure may be partially or entirely combined with each other, and may be technically associated with each other or operate with each other. The embodiments may be implemented independently of each other or may be implemented together in an association relationship.

Unless otherwise defined, all terms including technical and scientific terms used herein have the same meaning as commonly understood by one of ordinary skill in the art to which the present disclosure belongs. It should be further understood that terms, such as those defined in commonly used dictionaries, should be interpreted as having a meaning that is consistent with their meaning in the context of the relevant art and will not be interpreted in an idealized or overly formal sense unless expressly so defined herein.

In description of flow of a signal, for example, where a signal is described as being delivered from a node A to a node B, this may include a case where the signal is transferred from the node A to the node B via another node unless a more limiting phrase like ‘immediately transferred’ or ‘directly transferred’ is used. Throughout the present disclosure, if used, “A and/or B” means A, B, or A and B, unless otherwise specified, and “C to D” means C inclusive to D inclusive unless otherwise specified. In interpreting a numerical value, the value is to be interpreted as including an error range unless otherwise specified. Further, the term ‘or’ means ‘inclusive or’ rather than ‘exclusive or’. That is, unless otherwise stated or clear from the context, the expression that ‘x uses a or b’ means one of natural inclusive permutations.

In a display device of the present disclosure, each of a pixel circuit and a gate driver may include a plurality of transistors. The transistor may be embodied as an oxide thin-film transistor (oxide TFT) including an oxide semiconductor or as a LTPS TFT including low temperature poly silicon (LTPS).

The transistor is a three-electrode element including a gate, a source, and a drain. The source is an electrode that supplies a carrier to the transistor. In the transistor, the carrier begins to flow from the source. The drain is an electrode through which carriers exit from the transistor. The carriers in the transistor flow from the source to the drain.

In an N-type transistor, the carriers are electrons. Thus, a source voltage may be lower than a drain voltage so that the electrons can flow from the source to the drain. In the N-type transistor, a direction of the current is a direction from the drain to the source.

In a P-type transistor, the carrier is a hole. Thus, the source voltage is higher than the drain voltage so that the hole can flow from the source to the drain. In the P-type transistor, current flows from the source to the drain because holes flow from the source to the drain.

It should be noted that the source and drain of the transistor are not fixed. For example, the source and the drain may be changed according to an applied voltage. Accordingly, the present disclosure is not limited due to positions of the source and the drain of the transistor. In following descriptions, the source and the drain of the transistor may be referred to as first and second electrodes, respectively.

According to one or more example embodiments, a scan signal may swing to between a gate on voltage and a gate off voltage. The transistor is turned on in response to the gate-on voltage, whereas the transistor is turned off in response to the gate-off voltage. In the case of the N-type transistor, the gate-on voltage may be a gate high voltage, and the gate-off voltage may be a gate low voltage. In the case of the P-type transistor, the gate-on voltage may be the gate low voltage, and the gate-off voltage may be the gate high voltage. In the pixel circuit of the present disclosure, each of the remaining transistors except for the driving transistor may be referred to as a switching transistor.

Hereinafter, various example embodiments of the present disclosure will be described in detail with reference to the accompanying drawings.

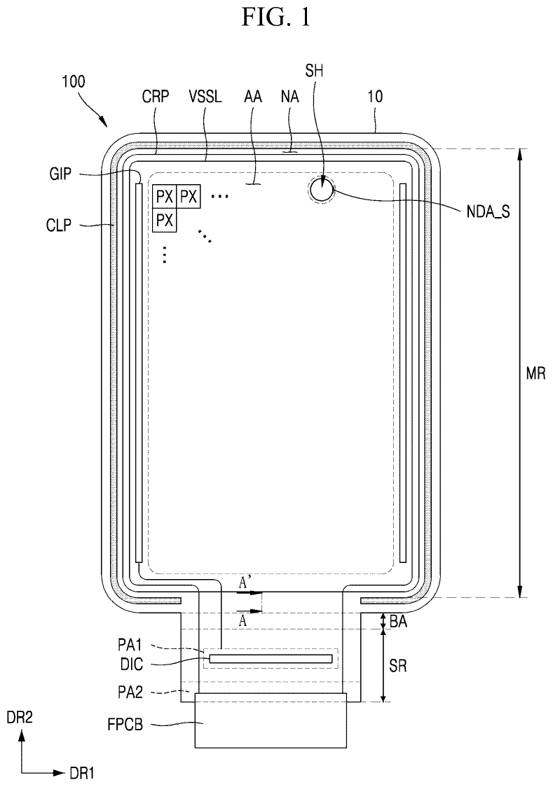

FIG. 1 is a plan view illustrating a display device according to an example embodiment of the present disclosure.

As shown in FIG. 1, a display device 100 according to an embodiment of the present disclosure may include a substrate 10.

According to an embodiment, the substrate 10 may include a plurality of areas. The plurality of areas may include a main area MR, a bendable area BA, and a sub-area SR.

According to an embodiment, the main area MR may include a display area or an active area AA and a non-display area or a non-active area NA. The bendable area BA may be an area that is bent in a thickness direction from the main area MR. The sub-area SR may be an area connected to the bendable area BA and opposite to the main area MR while the bendable area BA is disposed therebetween.

According to an embodiment, the display area AA may be an area in which an image is displayed. The non-display area NA may be an area other than the display area AA. Although not shown, a pixel array may be formed in the display area AA.

According to an embodiment, one or more non-display areas NA in which an image is not displayed may include a driving circuit area DIC and a clad area CLP serving as a dam, and may be provided on at least one side of the display area AA. For example, the non-display area NA may be adjacent to one or more sides of the display area AA.

According to an embodiment, the non-display area NA may surround a rectangular display area AA and may be located outwardly thereof. However, it should be understood that the shape of the display area AA and the arrangement of the non-display area NA adjacent to the display area AA are not specifically limited to those in the example display device 100 illustrated in FIG. 1. Each of the display area AA and the non-display area NA of the display device 100 may have any shape. Non-limiting examples of such a shape may include a pentagonal, hexagonal, circular or elliptical shape. However, embodiments of the present disclosure are not limited thereto.

According to an embodiment, a crack detection pattern CRP may be disposed in the non-display area NA so as to surround three sides of the display area AA. The crack detection pattern CRP may be used to detect a state in which a crack occurs in the substrate 10.

According to an embodiment, in the plan view, a low-potential power line VSSL may be disposed between the crack detection pattern CRP and the display area AA so as to surround three sides of the display area AA.

According to an embodiment, in the plan view, a gate driver GIP may be disposed in each of the non-display areas NA disposed respectively on both opposing sides of the display area AA. The gate driver GIP supplies a gate signal (or a scan signal) to the display area AA.

According to an embodiment, the display area AA may include a second non-display area NDA_S in which a camera area SH is disposed. A camera may be disposed inside the camera area SH.

According to an embodiment, the bendable area BA may be disposed between the main area MR and the sub-area SR, and may connect the main area MR and the sub-area SR to each other. A width of the bendable area BA in the first direction DR1 may be smaller than each of a width of the main area MR in the first direction DR1 and a width of the sub-area SR in the first direction DR1.

The display device 100 may further include a plurality of lines extending from the sub-area SR across the bendable area BA to the main area MR. The plurality of lines may include a first line to which a first voltage is applied, a second line to which a second voltage is applied, and a dummy line which is disposed between the first line and the second line and to which a third voltage is applied.

Although not shown, the display device 100 may further include a data driver DIC disposed in the sub-area SR, and each of the first line and the second line may be connected to the data driver DIC.

According to an embodiment, the display area AA may include a plurality of pixels PX. One pixel PX may include a plurality of sub-pixels. Each of the plurality of sub-pixels may include a light-emitting element. The light-emitting element may be an inorganic light-emitting element or an organic light-emitting element. However, embodiments of the present disclosure are not limited thereto. The plurality of sub-pixels may respectively display colors such as red (R), green (G), blue (B), and white (W). The plurality of sub-pixels may be disposed in the display area AA, and each sub-pixel may include one or more transistors. At least one transistor and the light-emitting element may be connected to each other.

In addition, each of the pixels and the sub-pixels may be related to a pixel circuit including one or more TFTs fabricated on the substrate 10 of the display device 100. Each of the pixel circuits may be electrically connected to the gate line and the data line to communicate with one or more driving circuits, for example, the gate driver GIP and the data driver DIC located in the non-display area NA of the display device 100.

According to an embodiment, the sub-area SR may include a first pad area PA1 and a second pad area PA2. The data driver DIC may be disposed in the first pad area PA1, and the flexible circuit board FPCB may be disposed in the second pad area PA2.

According to an embodiment, one or more driving circuits may be embodied as TFTs disposed in the non-display area NA. For example, the gate driver GIP may be implemented using a plurality of TFTs disposed on the substrate 10 of the display device 100. Non-limiting examples of circuits that may be implemented using the TFTs on the substrate 10 may include an inverter circuit, a multiplexer, an electro static discharge (ESD) circuit, etc. However, embodiments disclosed herein are not limited thereto.

According to an embodiment, each of some driving circuits may be provided as an integrated circuit (IC) chip which may be mounted in the non-display area NA of the display device 100 in a chip-on-glass (COG) manner or in another similar manner thereto. In addition, each of the others driving circuits may be mounted on another substrate and may be coupled to a connection interface (pads/bumps, pins) disposed in the non-display area NA using a flexible circuit board (FPCB), a chip-on-film (COF), a tape-carrier-package (TCP), or other suitable techniques.

In embodiments as disclosed herein, at least two different types of TFTs are used in a TFT substrate for display. A type of TFT employed in each of a portion of the pixel circuit and a portion of the driving circuit may vary according to the specifications of the display device.

For example, the pixel circuit may be implemented using TFT (oxide TFT) having an oxide active layer, and the driving circuit may be implemented using TFT (LTPS TFT) having a low temperature polycrystalline silicon active layer, and TFT having an oxide active layer. Unlike the LTPS TFT, the oxide TFT does not suffer from the pixel-to-pixel or inter-pixel threshold voltage (Vth) fluctuation problem. The uniform threshold voltage Vth may also be obtained in an array of pixel circuits for display. The uniformity of the threshold voltage Vth between the TFTs constituting the driving circuit may have less direct influence on the luminance uniformity of the pixels.

Using the driving circuits disposed on the substrate which are implemented using the LTPS TFTs, signals and data may be provided to the pixels at a higher clock rate than that when all TFTs in a TFT panel include the oxide TFTs. Accordingly, a display device capable of performing a high-speed operation may be provided without defects such as mura. For example, the advantages of the oxide TFT and the LTPS TFT may be used in combination with the design of the TFT panel such that the oxide TFT and the LTPS TFT may be selectively employed based on the advantage thereof.

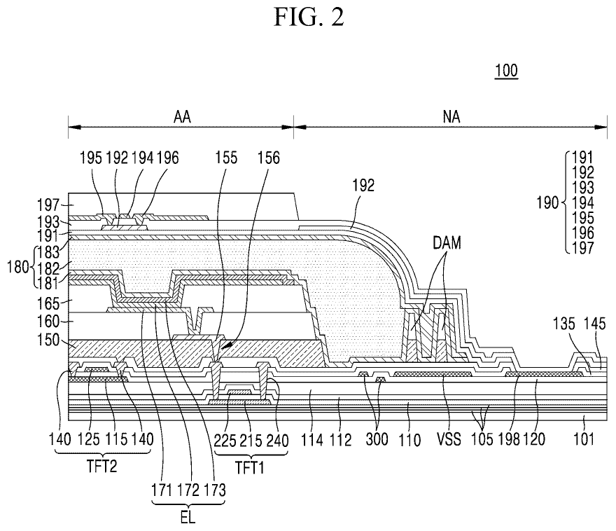

FIG. 2 is a cross-sectional view illustrating a stack form of a display device according to an example embodiment of the present disclosure.

As shown in FIG. 2, a first thin-film transistor TFT1 and a second thin-film transistor TFT2 for driving a light-emitting element EL may be disposed in the display area AA and on the substrate 101.

In addition, although the first and second thin-film transistors TFT1 and TFT2 have a coplanar structure in the present disclosure, the thin-film transistor may be implemented in another structure such as a staggered structure.

According to an embodiment, as illustrated in FIG. 2, the first thin-film transistor TFT1 may include a first semiconductor layer 215 disposed on a buffer layer 105, a first gate electrode 225 vertically overlapping the first semiconductor layer 215 while a first insulating layer 110 is interposed therebetween, and first source and drain electrodes 240 in contact with the first semiconductor layer 215.

According to an embodiment, the first semiconductor layer 215 may be made of polycrystalline silicon (poly-Si). However, embodiments of the present disclosure are not limited thereto. The first semiconductor layer 215 may be formed on the buffer layer 105. The buffer layer 105 may delay diffusion of moisture and/or oxygen having penetrated into the substrate 101. The buffer layer 105 may have a structure in which a silicon nitride (SiNx) layer and a silicon oxide (SiOx) layer are stacked.

According to an embodiment, the first gate electrode 225 may be formed on the first insulating layer 110, and may vertically overlap a channel area of the first semiconductor layer 215 while the first insulating layer 110 is interposed therebetween. The first insulating layer 110 may be made of silicon nitride (SiNx) or silicon oxide (SiOx).

The first gate electrode 225 may be composed of a single layer or a stack of multiple layers made of one of magnesium (Mg), molybdenum (Mo), aluminum (Al), chromium (Cr), gold (Au), titanium (Ti), nickel (Ni), neodymium (Nd), and copper (Cu) or an alloy thereof. However, embodiments of the present disclosure are not limited thereto.

A second insulating layer 112 may cover the first gate electrode 225 and may be disposed on the first insulating layer 110. The second insulating layer 112 may be made of silicon nitride (SiNx) or silicon oxide (SiOx).

A third insulating layer 114 may be disposed on the second insulating layer 112. The third insulating layer 114 may be made of silicon nitride (SiNx) or silicon oxide (SiOx).

According to an embodiment, as illustrated in FIG. 2, the second thin-film transistor TFT2 may include a second semiconductor layer 115 disposed on the third insulating layer 114, a second gate electrode 125 vertically overlapping the second semiconductor layer 115 while the fourth insulating layer 120 is interposed therebetween, and second source and drain electrodes 140 in contact with the second semiconductor layer 115.

According to an embodiment, the second semiconductor layer 115 may be made of an oxide semiconductor material. However, embodiments of the present disclosure are not limited thereto.

According to an embodiment, the second gate electrode 125 may be formed on the fourth insulating layer 120, and may vertically overlap a channel area of the second semiconductor layer 115 while a fourth insulating layer 120 is interposed therebetween. The fourth insulating layer 120 may be made of silicon nitride (SiNx) or silicon oxide (SiOx). The second gate electrode 125 may be composed of a single layer or a stack of multiple layers made of one of magnesium (Mg), molybdenum (Mo), aluminum (Al), chromium (Cr), gold (Au), titanium (Ti), nickel (Ni), neodymium (Nd), and copper (Cu) or an alloy thereof. However, embodiments of the present disclosure are not limited thereto.

A fifth insulating layer 135 may be disposed on the fourth insulating layer 120 so as to cover the second gate electrode 125.

The first source and drain electrodes 240 and the second source and drain electrodes 140 may be disposed on the fifth insulating layer 135.

According to an embodiment, each of the first source and drain electrodes 240 may be connected to the first semiconductor layer 215 via each of contact holes extending through the first insulating layer 110, the second insulating layer 112, the third insulating layer 114, the fourth insulating layer 120, and the fifth insulating layer 135. Each of the second source and drain electrodes 140 may be connected to the second semiconductor layer 115 via each of contact holes extending through the fourth insulating layer 120 and the fifth insulating layer 135.

Each of the first source and drain electrodes 240 and the second source and drain electrodes 140 may be composed of a single layer or a stack of multiple layers made of one of molybdenum (Mo), aluminum (Al), chromium (Cr), gold (Au), titanium (Ti), nickel (Ni), neodymium (Nd), and copper (Cu), or an alloy thereof. However, embodiments of the present disclosure are not limited thereto.

A protective film 145 may be disposed on the fifth insulating layer 135 so as to cover the first source and drain electrodes 240 and the second source and drain electrodes 140.

A first middle layer 150 and a second middle layer 160 may be stacked on the protective film 145.

According to an embodiment, a connection electrode 155 may be disposed between the first middle layer 150 and the second middle layer 160. The connection electrode 155 may be connected to one of the first source and drain electrodes 240 via a connection electrode contact hole 156 extending through the protective film 145 and the first middle layer 150. The connection electrode 155 may be made of a material having a low resistivity, which is the same as or similar to a material of each of the first source and drain electrodes 240. However, embodiments of the present disclosure are not limited thereto.

As shown in FIG. 2, the light-emitting element EL including a light-emitting layer 172 may be disposed on the second middle layer 160 and a bank layer 165. The light-emitting element EL may include an anode electrode 171, at least one light-emitting layer 172 formed on the anode electrode 171, and a cathode electrode 173 formed on the light-emitting layer 172.

According to an embodiment, the anode electrode 171 may be disposed on the first middle layer 150, and may be electrically connected to the connection electrode 155 via a contact hole extending through the second middle layer 160.

According to an embodiment, a portion of the anode electrode 171 of each pixel is not covered with the bank layer 165 so as to be exposed, and a remaining portion of the anode electrode 171 of each pixel is covered with the bank layer 165 so as to be not exposed. The bank layer 165 may be made of an opaque material (e.g., black) to prevent or suppress optical interference between adjacent pixels. In this case, the bank layer 165 may include a light blocking material including at least one of a color pigment, organic black, and carbon. However, embodiments of the present disclosure are not limited thereto.

As shown in FIG. 2, the at least one light-emitting layer 172 may be formed on the anode electrode 171 of a light emission area EA defined by the bank layer 165. The at least one light-emitting layer 172 may include a hole transport layer, a hole injection layer, a hole blocking layer, a light-emitting layer, an electron injection layer, an electron blocking layer, an electron transport layer, etc. disposed on the anode electrode 171. The hole transport layer, the hole injection layer, the hole blocking layer, the light-emitting layer, the electron injection layer, the electron blocking layer, the electron transport layer, etc. may be sequentially stacked in this order or in a reverse direction thereto according to a light emission direction. In addition, the light-emitting layer 172 may include first and second light-emitting stacks opposite to each other with a charge generation layer interposed therebetween. In this case, the light-emitting layer 172 of one of the first and second light-emitting stacks may generate blue light, while the light-emitting layer 172 of the other of the first and second light-emitting stacks may generate yellow-green light, thereby generating white light through the first and second light-emitting stacks. The white light generated through the first and second light-emitting stacks is incident on a color filter located on top of or under the light-emitting layer 172, such that a color image may be realized. In another example, a color image may be realized by respectively generating R, G, and B color light beams in R, G, and B pixels respectively including R, G, and B light-emitting layers 172 without a separate color filter. For example, the light-emitting layer 172 of the red pixel may generate red light, the light-emitting layer 172 of the green pixel may generate green light, and the light-emitting layer 172 of the blue pixel may generate blue light.

As shown in FIG. 2, the cathode electrode 173 may face the anode electrode 171 with the light-emitting layer 172 interposed therebetween, and may receive the high potential driving voltage EVDD.

According to an embodiment, an encapsulation layer 180 may prevent or block external moisture or oxygen from penetrating into the light-emitting element EL which is vulnerable to external moisture or oxygen. To this end, the encapsulation layer 180 may include at least one inorganic encapsulation layer and at least one organic encapsulation layer. However, embodiments of the present disclosure are not limited thereto. In the present disclosure, a structure of the encapsulation layer 180 in which a first encapsulation layer 181, a second encapsulation layer 182, and a third encapsulation layer 183 are sequentially stacked will be described by way of example.

According to one embodiment, the first encapsulation layer 181 may be formed on the substrate 101 on which the cathode electrode 173 has been formed. The third encapsulation layer 183 may be formed on the substrate 101 on which the second encapsulation layer 182 has been formed. The third encapsulation layer 183 and the first encapsulation layer 181 may surround a top face, a bottom face and a side face of the second encapsulation layer 182. The first encapsulation layer 181 and the third encapsulation layer 183 may block, minimize, or prevent penetration of external moisture or oxygen into the light-emitting element EL. Each of the first encapsulation layer 181 and the third encapsulation layer 183 may be made of an inorganic insulating material that may be deposited at a low temperature, such as silicon nitride (SiNₓ), silicon oxide (SiOₓ), silicon oxynitride (SiON), or aluminum oxide (Al₂O₃). However, embodiments of the present disclosure are not limited thereto. Each of the first encapsulation layer 181 and the third encapsulation layer 183 is deposited in a low temperature atmosphere. Thus, during a deposition process of the first encapsulation layer 181 and the third encapsulation layer 183, the light-emitting element EL which is vulnerable to a high-temperature atmosphere may be prevented or protected from being damaged.

According to one embodiment, the second encapsulation layer 182 serves as a shock-absorbing layer to relieve a stress between layers due to bending of the display device 100, and may planarize a step between layers. The second encapsulation layer 182 may be made of a non-photosensitive organic insulating material such as acryl resin, epoxy resin, phenolic resin, polyamide resin, polyimide resin, polyethylene or silicon oxycarbon (SiOC) or a photosensitive organic insulating material such as photoacryl. However, embodiments of the present disclosure are not limited thereto. When the second encapsulation layer 182 is formed using an inkjet method, a dam may be disposed to prevent or block the second encapsulation layer 182 in a liquid state from spreading to an edge of the substrate 101. The dam DAM may be closer to the edge of the substrate 101 than the second encapsulation layer 182 may be. The dam DAM may prevent or block the second encapsulation layer 182 in the liquid state from spreading to a pad area where a conductive pad disposed at the outermost side of the substrate 101 is disposed.

According to one embodiment, the dam DAM is designed to prevent or block diffusion of the second encapsulation layer 182. However, when the second encapsulation layer 182 overflows the dam DAM during a process, the second encapsulation layer 182 as an organic layer may be exposed to an outside, so that moisture or the like may invade the light-emitting element. Therefore, to prevent or block the invasion, at least ten dams DAM may be stacked. However, embodiments of the present disclosure are not limited thereto.

As shown in FIG. 2, the dam DAM may be disposed on the protective film 145 and in the non-display area NA.

Further, the dam DAM, and the first middle layer 150 and the second middle layer 160 may be formed simultaneously. However, embodiments of the present disclosure are not limited thereto. The first middle layer 150, and a lower layer of the dam DAM may be formed simultaneously. The second middle layer 160, and an upper layer of the dam DAM may be formed simultaneously. Thus, the dam DAM may have a double layer structure. However, embodiments of the present disclosure are not limited thereto.

Accordingly, the dam DAM may be made of the same material as that of each of the first middle layer 150 and the second middle layer 160. However, embodiments of the present disclosure are not limited thereto.

As shown in FIG. 2, the dam DAM may overlap the low-potential driving power line VSS. For example, the low-potential driving power line VSS may be formed in a layer under the dam DAM and in the non-display area NA.

According to one embodiment, the low-potential driving power line VSS and a gate driver 300 in a form of a gate in panel (GIP) may surround a periphery of the display panel. The low-potential driving power line VSS may be located outwardly of the gate driver 300. Further, the low-potential driving power line VSS may be connected to the anode electrode 171 to apply a common voltage thereto. The gate driver 300 is simply illustrated in plan and cross-sectional views. However, the gate driver 300 may be configured using a thin-film transistor (TFT) having the same structure as that of the second thin-film transistor TFT2 of the display area AA. However, embodiments of the present disclosure are not limited thereto.

As shown in FIG. 2, the low-potential driving power line VSS may be disposed outwardly of the gate driver 300. The low-potential driving power line VSS may be disposed outwardly of the gate driver 300 and may surround the display area AA. For example, the low-potential driving power line VSS may be made of the same material as that of each of the second source and drain electrodes 140. However, embodiments of the present disclosure are not limited thereto. For example, the low-potential driving power line VSS may be made of the same material as that of the second gate electrode 125. However, embodiments of the present disclosure are not limited thereto.

Further, the low-potential driving power line VSS may be electrically connected to the anode electrode 171. The low-potential driving power line VSS may supply the low-potential driving voltage EVSS to the plurality of pixels in the display area AA.

According to an example embodiment, a touch layer 190 may be disposed on the encapsulation layer 180. In the touch layer 190, a touch buffer film 191 may be positioned between a touch sensor metal including touch electrode connection lines 192 and 194 and touch electrodes 195 and 196 and the cathode electrode 173 of the light-emitting element EL.

According to an example embodiment, the touch buffer film 191 may prevent or block chemical (developer, etchant, etc.) used in a manufacturing process of the touch sensor metal disposed on the touch buffer film 191 or moisture from the outside from invading the light-emitting layer 172 including an organic material. Accordingly, the touch buffer film 191 may prevent or suppress damage to the light-emitting layer 172 as vulnerable to the chemicals or moisture.

According to an example embodiment, the touch buffer film 191 may be made of an organic insulating material that can be formed at a low temperature below or equal to a certain temperature (100 degrees Celsius) to prevent or suppress damage to the light-emitting layer 172 including the organic material vulnerable to a high temperature, and that has a low dielectric constant of 1 to 3. However, embodiments of the present disclosure are not limited thereto. For example, the touch buffer film 191 may be made of an acryl-based, epoxy-based, or siloxane-based material. However, embodiments of the present disclosure are not limited thereto. The touch buffer film 191 made of the organic insulating material and having planarization performance may prevent or suppress damage to the encapsulation layer 180 and fracture of the touch sensor metal formed on the touch buffer film 191 due to bending of the display device.

According to an example embodiment, based on a mutual-capacitance-based touch sensor structure, the touch electrodes 195 and 196 may be disposed on the touch buffer layer 191, and the touch electrodes 195 and 196 may be disposed to intersect each other. However, embodiments of the present disclosure are not limited thereto.

According to example embodiment, the touch electrode connection lines 192 and 194 may electrically connect the touch electrodes 195 and 196 to each other. The touch electrode connection lines 192 and 194 and the touch electrodes 195 and 196 may be positioned on different layers while the touch insulating film 193 is interposed therebetween. However, embodiments of the present disclosure are not limited thereto.

According to an example embodiment, the touch electrode connection lines 192 and 194 may overlap the bank layer 165, thereby preventing or suppressing an aperture ratio of the display device from being lowered.

According to an example embodiment, a portion of the touch electrode connection line 192 may extend along upper and side surfaces of the encapsulation layer 180 and upper and side surfaces of the dam DAM and then may be electrically connected to a touch driver circuit (not shown) via a touch pad 198. Thus, the touch electrodes 195 and 196 may be electrically connected to the touch driver circuit.

According to an example embodiment, the portion of the touch electrode connection line 192 may receive a touch driving signal from the touch driver circuit and transmit the same to the touch electrodes 195 and 196, and may receive a touch sensing signal from the touch electrodes 195 and 196 and may transmit the same to the touch driver circuit.

According to an example embodiment, a touch protective film 197 may be disposed on the touch electrodes 195 and 196. In the drawing, it is shown that the touch protective film 197 is disposed only on the touch electrodes 195 and 196. However, embodiments of the present disclosure are not limited thereto. The touch protective film 197 may extend to an inner end or an outer end of the dam DAM and thus may also be disposed on the touch electrode connection line 192.

Further, a color filter (not shown) may be further disposed on the encapsulation layer 180, and the color filter may be positioned on the touch layer 190 or between the encapsulation layer 180 and the touch layer 190. However, embodiments of the present disclosure are not limited thereto.

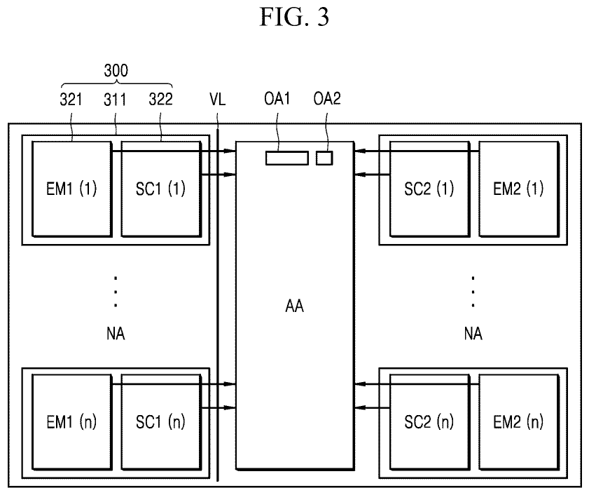

FIG. 3 is a diagram illustrating a configuration of a gate driver in a display device according to an example embodiment of the present disclosure.

As shown in FIG. 3, the gate driver (GIP) 300 may include an emission control signal driver 321 and a scan driver 322. The scan driver 322 may include a first scan driver and a second scan driver.

According to an embodiment, the gate driver 300 may include shift registers which may be respectively disposed on both opposing sides of the display area AA symmetrically.

According to an embodiment, each of stages STG(1) to STG(n) of the shift register may include a first scan signal generator SC1(1), a second scan signal generator SC2(1), and emission control signal generators EM1(1) to EM2(1).

According to an embodiment, the first scan signal generator outputs first scan signals through first scan lines SCL1 of the display panel 100. The second scan signal generator outputs second scan signals through second scan lines SCL2 of the display panel 100. The emission control signal generators EM1(1) to EM1(n) output emission control signals EM1(1) to EM1(n) through emission control lines EML of the display panel 100.

According to an embodiment, the first scan signals SC1(1) to SC1(n) may be used as signals for driving an A-th transistor (e.g., a compensation transistor) included in the pixel circuit. The second scan signals SC2(1) to SC2(n) may be used as signals for driving an B-th transistor (e.g., a data supply transistor) included in the pixel circuit. The emission control signals EM1(1) to EM1(n) may be used as signals for driving an E-th transistor (e.g., an emission control transistor) included in the pixel circuit. For example, when the emission control transistors of the pixels are controlled using the emission control signals EM(1) to EM(n), emission timings of the light-emitting elements may be controlled.

According to an embodiment, a bias voltage bus line VobsL, an anode reset voltage bus line VarL, and an initialization voltage bus line ViniL may be disposed between and connected to the gate driver 300 and the display area AA.

According to an embodiment, the bias voltage bus line VobsL, the anode reset voltage bus line VarL, and the initialization voltage bus line ViniL may supply the bias voltage Vobs, the anode reset voltage Var, and the initialization voltage Vini from the power supply to the pixel circuit, respectively.

According to an embodiment, as shown in FIG. 3, at least one optical area OA1 and OA2 may be disposed in the display area AA.

According to an embodiment, the at least one optical area OA1 and OA2 may be positioned so as to overlap at least one optical and electronic device, such as a capturing device such as a camera (an image sensor), and a detection sensor such as a proximity sensor and a luminance sensor.

According to an embodiment, for operation of the optical electronic device, the at least one optical area OA1 and OA2 may have a light transmissive structure and thus may have a transmittance equal to or greater than a predefined value. In other words, the number of pixels P per unit area in at least one optical area OA1 and OA2 may be smaller than the number of pixels P per unit area in a general area of the display area AA except for the at least one optical area OA1 and OA2. That is, a resolution of at least one optical area OA1 and OA2 may be lower than that of the general area of the display area AA.

According to an embodiment, the light transmissive structure of the at least one optical area OA1 and OA2 may be formed by patterning a cathode electrode in an area where the pixel P is not disposed. At this time, a portion of the cathode electrode to be patterned may be removed using a laser. Alternatively, the cathode electrode may be selectively formed so as to be patterned using a material such as a cathode deposition prevention layer.

Alternatively, the light transmissive structure of the at least one optical area OA1 and OA2 may be formed by forming the light-emitting element EL and the pixel circuit in a separated manner in the pixel P. In other words, the light-emitting element EL of the pixel P may be positioned on the at least one optical area OA1 and OA2, while a plurality of transistors TFT constituting the pixel circuit may be disposed around the at least one optical area OA1 and OA2, and the light-emitting element EL and the pixel circuit may be electrically connected to each other via a transparent metal layer.

Although not shown, a front dummy stage circuitry may sequentially generate a plurality of front carry signals in response to the gate start signal VST supplied from the timing controller (not shown) and supply the generated signal as a front carry signal or a gate start signal to one of the stages in rear thereof.

Although not shown, the rear dummy stage circuitry may sequentially generate a plurality of rear carry signals and supply the generated signal as a rear carry signal (or a stage reset signal) to one of the stages in front thereof.

The first to m-th stage circuits ST1 to STm may be connected to each other in a dependent manner. The first to m-th stage circuits ST1 to STm may respectively generate first to m-th scan signals SC1 to SCm and first to m-th sense signals SE1 to SEm and output the generated signals respectively to corresponding gate lines GL disposed in the display panel. Moreover, each of the first to m-th stage circuits ST1 to STm may generate each of first to m-th carry signals CS1 to CSm and supply the generated signal as a front carry signal (or a gate start signal) to one of the stages in rear thereof, and at the same time, supply the generated signal as a rear carry signal (or a stage reset signal) to one of the stages in front thereof.

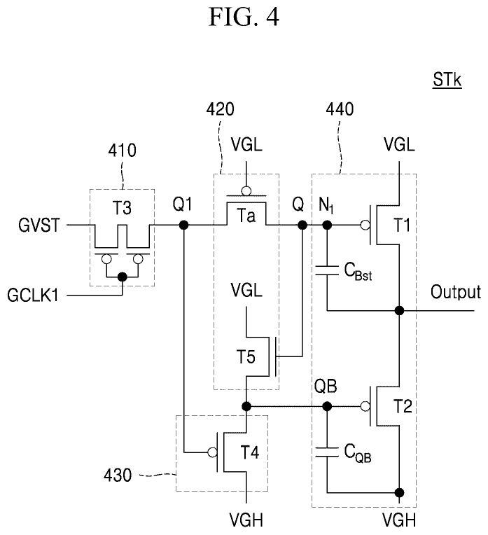

FIG. 4 is a circuit diagram of any k-th stage in a gate shift register of a gate driver according to an example embodiment of the present disclosure.

As shown in FIG. 4, the stage in the gate shift register according to an embodiment of the present disclosure may include an input unit (or circuit) 410, a Q-node control unit (or circuit) 420, an QB-node control unit (or circuit) 430, and an output unit (or circuit) 440.

According to an embodiment, the input unit 410 may operate based on one clock signal GCLK1 to transmit the gate low voltage VGL or the gate high voltage VGH to a first node Q1. For example, the input unit 410 may include one P-type switching transistor or may include two P-type switching transistors. The P-type switching transistor may operate based on the clock signal GCLK1.

According to an embodiment, the Q-node control unit 420 may operate based on the gate low voltage VGL to apply the gate low voltage VGL of the first node Q1 to a Q-node. Accordingly, as a Ta thin-film switching transistor Ta of the Q-node control unit 420 is turned on, the gate low signal VGL is transmitted from the first node Q1 to the Q-node.

In addition, a fifth switching transistor T5 of the Q-node control unit 420 is turned on in response to that a gate start signal GVST having a voltage level of the gate high signal VGH is applied to a gate electrode thereof through the input unit 410 and the Q-node. That is, when the Q-node is the gate high voltage VGH, the fifth switching transistor T5 is turned on, and a voltage VGS between the gate electrode and a source electrode of the fifth switching transistor T5 is a voltage VGH-VGL obtained by subtracting the gate low voltage VGL from the gate high voltage VGH. A drain electrode of the fifth switching transistor T5 of the Q-node control unit 420 is connected to a drain electrode of a fourth switching transistor T4 of the QB-node control unit 430. The pixel circuit may include a N-type transistor and a P-type transistor. The switching transistor T5 may be a N-type transistor or a P-type transistor. In addition, the switching transistor T5 may be a low temperature polycrystalline semiconductor (LTPS) transistor or an oxide transistor. In a CMOS in which the N-type transistor and the P-type transistor are included in the pixel circuit, a pair of the N-type transistor and the P-type transistor may constitute the pixel circuit.

According to an embodiment, the fourth switching transistor T4 of the QB-node control unit 430 may operate based on the gate low voltage VGL of the first node Q1 to apply the gate high voltage VGH to the QB-node. A drain electrode of the fourth switching transistor T4 is connected to the QB-node.

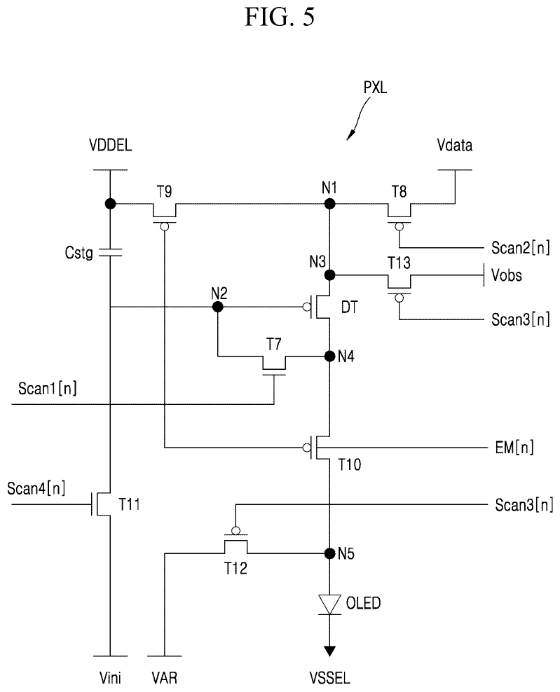

According to an embodiment, the output unit 440 may output the gate low voltage VGL of the Q-node to an output terminal Output. In addition, as the first switching transistor T1 is turned on according to the potential of the Q-node, the output unit 440 outputs the gate low voltage VGL. The output gate low voltage VGL acts as a third scan signal Scan3 of FIG. 5 which is transmitted to a gate electrode of a 12th switching transistor T12 and a gate electrode of a 13th switching transistor T13 of FIG. 5. A capacitor C_{Bst} is connected to and disposed between a gate electrode and a drain electrode of the first switching transistor T1. In addition, a capacitor C_{QB} is connected to and disposed between a gate electrode and a source electrode of a second switching transistor T2.

FIG. 5 is an example diagram illustrating a configuration of a pixel circuit of a display device according to an example embodiment of the present disclosure.

As shown in FIG. 5, the gate low voltage VGL output from FIG. 4 is transmitted to the gate electrode of the 12th switching transistor T12 and the gate electrode of the 13th switching transistor T13. The pixel circuit of the present disclosure includes seventh to thirteenth switching transistors T7 to T13, a driving transistor DT, a capacitor Cstg, and a light-emitting element OLED. The eighth to thirteenth switching transistors T8 to T13 and the driving transistor DT of the pixel circuit are embodied as P-type switching transistors, and are turned on upon receiving the gate low voltage VGL as the gate-on voltage. On the other hand, the seventh switching transistor T7 is embodied as a N-type switching transistor, and is turned on upon receiving the gate high voltage VGH as the gate-on voltage.

According to an embodiment, the active layers respectively constituting the driving transistor DT and the switching transistor ST may be made of the same material or different materials. When the driving transistor DT and the switching transistor ST in one pixel driving circuit are embodied as transistors having different characteristics, the display device may include multi-type transistors.

Specifically, in the display device including multi-type transistors, the LTPS transistor using low temperature polysilicon (Low Temperature Poly-Silicon; hereinafter, referred to as LTPS) is used as a transistor using a polycrystalline semiconductor material as a material of the active layer. The polysilicon material has high mobility (100 cm²/Vs or higher), low energy consumption, and excellent reliability, and thus may be applied to the gate driver 300 as a driving element for driving the transistors for the light-emitting element and/or the demultiplexer. Alternatively, the polysilicon material may be applied to the driving transistor in the pixel P in the display device.

In addition, in the display device including the multi-type transistors, the oxide semiconductor transistor using an oxide semiconductor material as a material of an active layer may be used. Since the oxide semiconductor material has a low off-current, the oxide semiconductor material may be suitable for a switching transistor that has a short turn-on time duration and maintains a long turn-off time duration. In terms of an ability of holding the voltage, the oxide semiconductor transistor is superior to the LTPS transistor.

For example, the display device including the multi-type transistors according to an embodiment of the present disclosure includes a pixel driving circuit in which the switching transistor includes the oxide semiconductor transistor, and the driving transistor includes the LTPS transistor. However, in the organic light-emitting display device of the present disclosure, the switching transistor is not limited to the oxide semiconductor transistor and the driving transistor is not limited to the LTPS transistor. Rather, the multi-type transistors may be variously configured.

According to an embodiment, the sub-pixel PXL may include a LTPS transistor and an oxide transistor. The sub-pixel PXL may be connected to lines respectively providing the data voltage Vdata, the high potential voltage VDDEL, the low potential voltage VSSEL, the reset voltage VAR, the on-bias stress voltage Vobs, the initialization voltage Vini, the emission signal EM[n], and the scan signals Scan1[n], Scan2[n], Scan3[n], and Scan4[n]. Accordingly, the pixel circuit of the sub-pixel PXL may receive the data voltage Vdata, the high potential voltage VDD, the low potential voltage VSS, the reset voltage VAR, the on-bias stress voltage Vobs, the initialization voltage Vini, the emission signal EM[n], and the scan signals Scan1[n], Scan2[n], Scan3[n], and Scan4[n]. In this regard, the data voltage Vdata may be an AC voltage (or alternate current voltage), while the reset voltage (or reference voltage) VAR, the initialization voltage Vini, the high potential voltage VDD, and the low potential voltage VSS may be DC voltages (or direct current voltages).

According to an embodiment, the gate electrode of the seventh switching transistor T7 which is the N-type transistor receives the first scan signal Scan1[n] of the n-th stage. A source electrode of the seventh switching transistor T7 is connected to a fourth node N4. A drain electrode of the seventh switching transistor T7 is connected to a gate electrode of the driving transistor DT via the second node N2. The gate electrode of the driving transistor DT is connected to the drain electrode of the seventh switching transistor T7 through the second node N2. The seventh switching transistor T7 is turned on based on the first scan signal Scan1[n] to control a voltage difference between the gate electrode and the drain electrode of the driving transistor DT to drive the driving transistor DT.

According to an embodiment, the gate electrode of the eighth switching transistor T8 receives the second scan signal Scan2[n] of the n-th stage. The source electrode of the eighth switching transistor T8 receives the data voltage Vdata. The drain electrode of the eighth switching transistor T8 is connected to the source electrode of the driving transistor DT via the first node N1. The eighth switching transistor T8 is turned on based on the second scan signal Scan2[n] to supply the data voltage Vdata to the source electrode of the driving transistor DT.

According to an embodiment, the gate electrode of the ninth switching transistor T9 receives the emission control signal EM[n]. The source electrode of the ninth switching transistor T9 is supplied with the high potential driving voltage VDDEL. The drain electrode of the ninth switching transistor T9 is connected to the source electrode of the driving transistor DT via the first node N1. The ninth switching transistor T9 is turned on based on the emission control signal EM[n] to supply the high potential driving voltage VDDEL to the source electrode of the driving transistor DT.

According to an embodiment, the gate electrode of the tenth switching transistor T10 receives the emission control signal EM[n] of the n-th stage. The source electrode of the tenth switching transistor T10 is connected to the drain electrode of the driving transistor DT. The drain electrode of the tenth switching transistor T10 is connected to the anode electrode of the light-emitting element OLED. The tenth switching transistor T10 is turned on based on the emission control signal EM to provide a driving current to the anode electrode of the light-emitting element OLED.

According to an embodiment, the gate electrode of the eleventh switching transistor T11 receives the fourth scan signal Scan4[n] of the n-th stage. The source electrode of the eleventh switching transistor T11 is supplied with the initialization voltage Vini. A drain electrode of the eleventh switching transistor T11 is connected to the capacitor Cstg. The eleventh switching transistor T11 is turned on based on the fourth scan signal Scan4[n].

According to an embodiment, the gate electrode of the 12th switching transistor T12 receives the third scan signal Scan3[n] from the n-th stage. The source electrode of the 12th switching transistor T12 is supplied with the variable anode reset voltage VAR. The drain electrode of the twelfth switching transistor T12 is connected to the anode electrode of the light-emitting element OLED via the fifth node N5. The anode electrode of the light-emitting element OLED is connected to the fifth node N5. The 12th switching transistor T12 is turned on based on the third scan signal Scan3[n] from the n-th stage to supply the anode reset voltage VAR to the anode electrode of the light-emitting element OLED.

According to an embodiment, the gate electrode of the 13th switching transistor T13 receives the third scan signal Scan3[n] of the n-th stage. The source electrode of the thirteenth switching transistor T13 is supplied with the on-bias stress voltage Vobs. The drain electrode of the thirteenth switching transistor T13 is connected to the source electrode of the driving transistor DT. The source electrode of the driving transistor DT is connected to the third node N3. The 13th switching transistor T13 is turned on based on the third scan signal Scan3[n] to supply the initialization voltage Vini to the drain electrode of the driving transistor DT.

According to an embodiment, the gate electrode of the driving transistor DT is connected to the drain electrode of the seventh switching transistor T7 via the second node N2. The source electrode of the driving transistor DT is connected to the drain electrode of the 13th switching transistor T13 via the third node N3. In addition, the source electrode of the driving transistor DT is connected to the drain electrode of the eighth transistor T8 via the first node N1. The drain electrode of the driving transistor DT is connected to the source electrode of the tenth switching transistor T10. The driving transistor DT is turned on based on a voltage difference between the drain electrode and the gate electrode of the seventh switching transistor T7 to allow the driving current to flow to the light-emitting element OLED.

As described above, the seventh switching transistor T7 may be connected to and disposed between the gate electrode and the drain electrode of the driving transistor DT and may receive the first scan signal Scan1[n]. The eighth switching transistor T8 may be connected to and disposed between the source electrode of the driving transistor DT and a data voltage line providing the data voltage Vdata, and may receive the second scan signal Scan2[n]. The ninth switching transistor T9 may be connected to and disposed between the source electrode of the driving transistor DT and the high potential power line providing the high potential voltage VDD, and may receive the emission signal EM[n]. The tenth switching transistor T10 may be connected to and disposed between the drain electrode of the driving transistor DT and the anode electrode of the light-emitting element OLED and may receive the emission signal EM[n].

The eleventh switching transistor T11 may be connected to and disposed between the capacitor Cstg and the initialization voltage line providing the initialization voltage Vini, and may receive the fourth scan signal Scan4[n]. The twelfth switching transistor T12 may be connected to and disposed between a reference voltage line providing the reset voltage VAR and the anode electrode of the light-emitting element OLED and may receive the third scan signal Scan3[n]. The 13th switching transistor T13 may be connected to and disposed between the on-bias stress voltage line providing the on-bias stress voltage Vobs and the source electrode of the driving transistor DT, and may receive the third scan signal Scan3[n].

In addition, one side of the capacitor Cstg receives the high potential driving voltage VDDEL. The other side of the capacitor Cstg is connected to the gate electrode of the driving transistor DT via the second node N2. The capacitor Cstg stores therein a voltage of the gate electrode of the driving transistor DT.

According to an embodiment, the anode electrode of the light-emitting element OLED is connected to the node N5 to which the drain electrode of the tenth switching transistor T10 and the drain electrode of the twelfth switching transistor T12 are connected. The cathode electrode of the light-emitting element OLED receives the low potential driving voltage VSSEL. The light-emitting element OLED emits light at a predetermined luminance under the driving current flowing through the driving transistor DT.

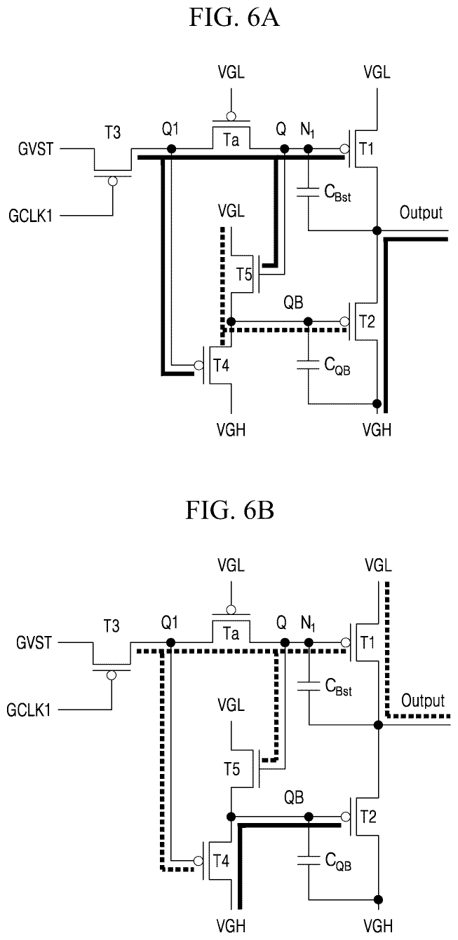

FIG. 6A is an example diagram illustrating a state in which a scan signal of a gate high voltage is output from a stage according to an example embodiment of the present disclosure. FIG. 6B is an example diagram illustrating a state in which a scan signal of a gate low voltage is output from a stage according to an example embodiment of the present disclosure.

As shown in FIG. 6A, the third switching transistor T3 may operate based on one clock signal GCLK1 to transmit the gate start signal GVST to each of the gate electrodes of the Ta thin-film switching transistor Ta and the fourth switching transistor T4 via the first node Q1.

The Ta thin-film switching transistor Ta is turned on based on the gate low voltage VGL, and transmits the gate start signal GVST transmitted from the third switching transistor T3 to the gate electrode of the fifth switching transistor T5 via the second node Q. The fifth switching transistor T5 is turned on based on the gate start signal GVST transmitted via the second node Q to transmit the gate low voltage VGL to the third node QB. In addition, the first switching transistor T1 is turned off based on the gate start signal GVST transmitted via the second node Q.

The fourth switching transistor T4 is turned off based on the gate start signal GVST transmitted via the first node Q1. In addition, the second switching transistor T2 is turned on based on the gate low voltage VGL transmitted to the gate electrode of the second switching transistor T2 via the third node QB, so that the gate high voltage VGH is output.

When the gate high voltage VGH is output, the fifth switching transistor T5 is brought into a high state.

As shown in FIG. 6B, the circuit configuration of FIG. 6B is substantially the same as the circuit configuration of FIG. 6A, and the redundant description of FIG. 6B is omitted because the technical descriptions of FIG. 6A may be equally applied to the description of FIG. 6B.

The fifth switching transistor T5 is turned off based on the gate start signal GVST transmitted via the second node Q. In addition, the first switching transistor T1 is turned on based on the gate start signal GVST transmitted via the second node Q, and the gate low voltage VGL applied via the source electrode of the first switching transistor T1 is output.

The fourth switching transistor T4 is turned on based on the gate start signal GVST transmitted via the first node Q1, and the gate high voltage VGH transmitted via the source electrode of the fourth switching transistor is transmitted to the third node QB. In addition, the second switching transistor T2 is turned off based on the gate high voltage VGH transmitted to the gate electrode of the second switching transistor T2 via the third node QB.

When the gate low voltage VGL is output, the fifth switching transistor T5 is brought into a high state.

In FIGS. 6A and 6B, a thick solid line represents a high voltage, and a thick dotted line represents a low voltage. As described above, the high voltage is continuously applied to the gate electrode of the fifth switching transistor T5 in the stage of the gate driver. Thus, the fifth switching transistor T5 is vulnerable to positive bias temperature stress (PBTS).

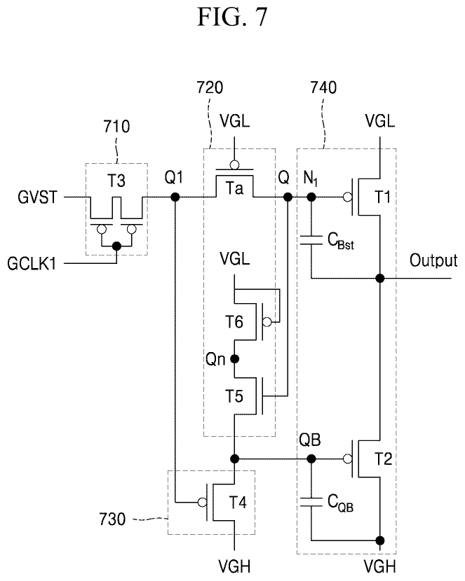

FIG. 7 is a circuit diagram of any stage in a gate shift register of a gate driver according to another example embodiment of the present disclosure.

As shown in FIG. 7, the stage in the gate shift register according to another embodiment of the present disclosure may include an input unit (or circuit) 710, an Q-node control unit (or circuit) 720, an QB-node control unit (or circuit) 730, and an output unit (circuit) 740. The circuit configuration of FIG. 7 is substantially the same as the circuit configuration of FIG. 4 except that a sixth switching transistor T6 connected to the source electrode of the fifth switching transistor T5 is added to the circuit configuration of FIG. 7. Thus, the technical description of FIG. 7 is omitted because the technical description of FIG. 4 may be equally applied to the technical description of FIG. 7.

According to an embodiment, the input unit 710 may include one P-type switching transistor or may include two P-type switching transistors. The P-type switching transistor may be turned on based on the clock signal GCLK1.

According to an embodiment, the Q-node control unit 720 may include a Ta thin-film switching transistor Ta which operates based on the gate low voltage VGL to apply the gate low voltage VGL of the first node Q1 to the Q node, the fifth switching transistor T5, and the sixth switching transistor T6. Accordingly, as the Ta thin-film switching transistor Ta of the Q-node control unit 720 is turned on, the gate low signal VGL is transmitted from the first node Q1 to the Q-node. When the gate high voltage VGH is applied, the Q-node control unit 720 may not apply the gate low voltage VGL of the first node Q1 to the Q-node.

The sixth switching transistor T6 of the Q-node control unit 720 is turned on based on the gate low voltage VGL, and transmits the gate low voltage VGL applied to the source electrode of the sixth switching transistor T6 to the source electrode of the fifth switching transistor T5 via a fourth node Qn.

As described above, the high voltage of the third scan signal Scan3[n] is continuously applied to the gate electrode of the fifth switching transistor T5, such that the threshold voltage Vth shift thereof occurs. Thus, the fifth switching transistor T5 is not turned on, so that a defect of the gate driver GIP occurs.

On the contrary, as illustrated in FIG. 7, the sixth switching transistor T6 may be additionally connected to the source electrode of the fifth switching transistor T5 to lower the voltage VGS between the gate electrode and the source electrode of the fifth switching transistor T5. When the voltage VGS between the gate electrode and the source electrode of the fifth switching transistor T5 is lowered, the PBTS applied to the fifth switching transistor T5 may be reduced, and thus, a reliable margin may be secured.

As illustrated in FIG. 7, the sixth switching transistor T6 is additionally disposed such that the drain electrode of the sixth switching transistor T6 is connected to the source electrode of the fifth switching transistor T5, and thus the voltage VGS between the gate electrode and the source electrode of the fifth switching transistor T5 becomes a voltage obtained by subtracting the gate low voltage VGL and the threshold voltage Vth from the gate high voltage VGH.

That is, the voltage VGS between the gate electrode and the source electrode of the fifth switching transistor T5 in FIG. 4 is a voltage (i.e., VGH−VGL) obtained by subtracting the gate low voltage VGL from the gate high voltage VGH, whereas the voltage VGS between the gate electrode and the source electrode of the fifth switching transistor T5 in FIG. 7 is a voltage (i.e., VGH−(VGL+Vth)) obtained by subtracting the gate low voltage VGL and the threshold voltage Vth from the gate high voltage VGH. Thus, the voltage VGS between the gate electrode and the source electrode of the fifth switching transistor T5 in FIG. 7 may be lowered by the threshold voltage Vth. The voltage VGS between the gate electrode and the source electrode of the fifth switching transistor T5 is lowered by the threshold voltage Vth, such that power consumption of the display device may be reduced, PBTS applied to the fifth switching transistor T5 may be reduced, and thus, a reliable margin may be secured.

As described above, the P-type transistor may be added to the circuit of the gate driver GIP corresponding to the third scan signal Scan3[n], such that the PBTS applied to the fifth switching transistor T5 may be reduced, and a reliable margin may be secured.

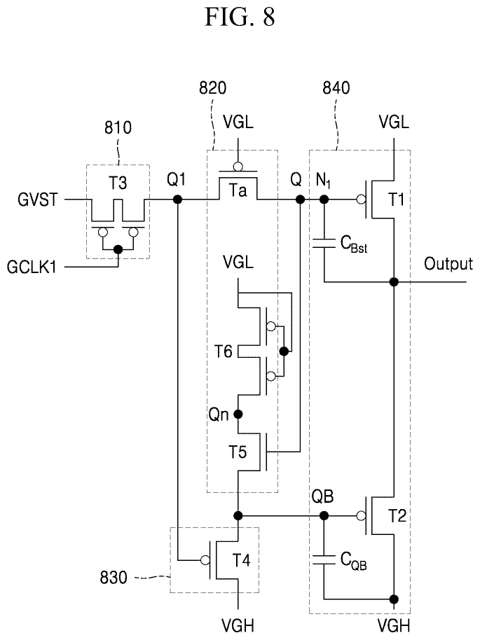

FIG. 8 is a circuit diagram of any stage in a gate shift register of a gate driver according to still another example embodiment of the present disclosure.

As shown in FIG. 8, the stage in the gate shift register according to still another embodiment of the present disclosure may include an input unit (or circuit) 810, a Q-node control unit (or circuit) 820, a QB-node control unit (or circuit) 830, and an output unit (or circuit) 840. The circuit configuration of FIG. 8 is substantially the same as the circuit configuration of FIG. 7, and thus the description of FIG. 8 is omitted because the technical description of FIG. 7 may be equally applied thereto.

According to an embodiment, the Q-node control unit 820 may include a Ta thin-film switching transistor Ta which operates based on the gate low voltage VGL to apply the gate low voltage VGL of the first node Q1 to the Q node, a fifth switching transistor T5, and a sixth switching transistor T6. For example, the sixth switching transistor T6 may include two P-type switching transistors.

According to an embodiment, the gate electrodes of the two P-type switching transistors of the sixth switching transistor T6 may be connected to each other, and the gate low voltage VGL may be applied thereto.

Accordingly, as the Ta thin-film switching transistor Ta of the Q-node control unit 820 is turned on, the gate low signal VGL is transmitted from the first node Q1 to the Q-node. When the gate high voltage VGH is applied, the Q-node control unit 820 may not apply the gate low voltage VGL of the first node Q1 to the Q-node.

The two sixth switching transistors T6 of the Q-node control unit 820 may be turned on based on the gate low voltage VGL. The gate electrode of the upper switching transistor ST among the two sixth switching transistors T6 is connected to the source electrode of the lower switching transistor ST among the two sixth switching transistors T6. In addition, the gate low voltage VGL applied to the source electrode of the upper switching transistor among the two sixth switching transistors T6 is transmitted to the drain electrode of the lower switching transistor and is transmitted to the source electrode of the fifth switching transistor T5 via the fourth node Qn.

As described above, the high voltage of the third scan signal Scan3[n] is continuously applied to the gate electrode of the fifth switching transistor T5, such that the threshold voltage Vth shift occurs. Thus, the fifth switching transistor T5 is not turned on, so that a defect of the gate driver GIP occurs.

On the contrary, as illustrated in FIG. 8, the two sixth switching transistors T6 are additionally connected to the source electrode of the fifth switching transistor T5, so that the voltage VGS between the gate electrode and the source electrode of the fifth switching transistor T5 may be lowered. In addition, lowering the voltage VGS between the gate electrode and the source electrode of the fifth switching transistor T5 may allow the PBTS applied to the fifth switching transistor T5 to be reduced. Thus, a reliable margin may be secured.

As illustrated in FIG. 8, the drain electrode of the upper or first switching transistor T6 of the two sixth switching transistors T6 is connected to the source electrode of the lower or second switching transistor T6 of the two sixth switching transistors T6. The drain electrode of the lower or second switching transistor T6 of the two sixth switching transistors T6 is connected to the source electrode of the fifth switching transistor T5.

The gate electrodes of the two sixth switching transistors T6 are connected to each other. Each of the two sixth switching transistors T6 is turned on in response to that the gate low voltage VGL is applied to the gate electrode thereof.

As described above, the voltage VGS between the gate electrode and the source electrode of the fifth switching transistor T5 becomes a voltage obtained by subtracting the gate low voltage VGL and the threshold voltage 2Vth of the combination of the two sixth switching transistors T6 from the gate high voltage VGH.

That is, in FIG. 4, the voltage VGS between the gate electrode and the source electrode of the fifth switching transistor T5 is a voltage (i.e., VGH−VGL) obtained by subtracting the gate low voltage VGL from the gate high voltage VGH, whereas in FIG. 8, the voltage VGS between the gate electrode and the source electrode of the fifth switching transistor T5 is a voltage (i.e., VGH−(VGL+2Vth) obtained by subtracting the gate low voltage VGL and the threshold voltage 2Vth of the combination of the two sixth switching transistors T6 from the gate high voltage VGH. Thus, in FIG. 8, the voltage VGS between the gate electrode and the source electrode of the fifth switching transistor T5 may be lowered by the threshold voltage 2Vth of the combination of the two sixth switching transistors T6. In addition, the voltage VGS between the gate electrode and the source electrode of the fifth switching transistor T5 is lowered by the threshold voltage 2Vth, such that power consumption of the display device may be reduced, and PBTS applied to the fifth switching transistor T5 may be reduced, and thus, a reliable margin may be secured.

As described above, the P-type transistor is added to the circuit of the gate driver GIP corresponding to the third scan signal Scan3[n], such that the PBTS applied to the fifth switching transistor T5 may be reduced, and a reliable margin may be secured.

A gate driver according to various example embodiments of the present disclosure may be described as follows.

One aspect of the present disclosure provides a gate driver comprising: a plurality of stages selectively connected to lines to which a plurality of clock signals are supplied, and configured to sequentially output a scan signal, wherein each of the plurality of stages includes: an input circuit configured to operate based on one clock signal to input a gate low voltage or a gate high voltage to a first node as a Q1 node; a Q-node control circuit configured to operate based on the gate high voltage of the first node to apply the gate high voltage of the first node to a second node as a Q node; a QB-node control circuit configured to operate based on the gate low voltage of the first node to apply the gate high voltage to a third node as a QB node; and an output circuit configured to output the gate low voltage to an output terminal of the stage based on the gate high voltage of the third node or to output the gate high voltage to the output terminal based on the gate high voltage of the second node, wherein the Q-node control circuit includes: a first switching transistor; and a second switching transistor for lowering a voltage between a gate electrode and a source electrode of the first switching transistor included in the Q-node control circuit.

In accordance with some embodiments of the gate driver, the Q-node control circuit includes different types of switching transistors.

In accordance with some embodiments of the gate driver, the first switching transistor is a N-type transistor, and the second switching transistor is a P-type transistor.

In accordance with some embodiments of the gate driver, the gate low voltage is applied to a source electrode and a gate electrode of the second switching transistor, wherein a drain electrode of the second switching transistor is connected to the source electrode of the first switching transistor.

In accordance with some embodiments of the gate driver, the source electrode of the first switching transistor is connected to a drain electrode of the second switching transistor, wherein the gate electrode of the first switching transistor is connected to the second node, wherein a drain electrode of the first switching transistor is connected to the third node.

In accordance with some embodiments of the gate driver, a voltage of a fourth node as a Qn node between the source electrode of the first switching transistor and a drain electrode of the second switching transistor is a sum of the gate low voltage and a threshold voltage of the second switching transistor.

In accordance with some embodiments of the gate driver, when the second node has the gate high voltage, a voltage between the gate electrode and the source electrode of the first switching transistor is a voltage obtained by subtracting the sum of the gate low voltage and the threshold voltage of the second switching transistor from the gate high voltage.

In accordance with some embodiments of the gate driver, the second switching transistor includes two P-type switching transistors.

In accordance with some embodiments of the gate driver, gate electrodes of the two P-type switching transistors of the second switching transistor are connected to each other.

In accordance with some embodiments of the gate driver, a drain electrode of a first P-type switching transistor of the two P-type switching transistors of the second switching transistor is connected to a source electrode of a second P-type switching transistor of the two P-type switching transistors of the second switching transistor, wherein a drain electrode of the second P-type switching transistor of the two P-type switching transistors of the second switching transistor is connected to the source electrode of the first switching transistor.

In accordance with some embodiments of the gate driver, when the second switching transistor includes the two P-type switching transistors, a voltage of a fourth node as a Qn node between the source electrode of the first switching transistor and a drain electrode of the second switching transistor is a sum of the gate low voltage and respective threshold voltages of the two P-type switching transistors.

In accordance with some embodiments of the gate driver, when the second node has the gate high voltage, a voltage between the gate electrode and the source electrode of the first switching transistor is a voltage obtained by subtracting the sum of the gate low voltage and the respective threshold voltages of the two P-type switching transistors from the gate high voltage.

A display device in accordance with some embodiments of the present disclosure may be described as follows.

Another aspect of the present disclosure provides a display device comprising: a display panel including a plurality of pixels, each including a plurality of sub-pixels; a data driver configured to apply a data signal to the display panel; a gate driver configured to apply a scan signal to the display panel, wherein the gate driver includes a plurality of stages; and a timing controller configured to control the data driver and the gate driver, wherein the plurality of stages are selectively connected to lines to which a plurality of clock signals are supplied, and are configured to sequentially output the scan signal, wherein each of the plurality of stages includes: an input circuit configured to operate based on one clock signal to input a gate low voltage or a gate high voltage to a first node as a Q1 node; a Q-node control circuit configured to operate based on the gate high voltage of the first node to apply the gate high voltage of the first node to a second node as a Q node; a QB-node control circuit configured to operate based on the gate low voltage of the first node to apply the gate high voltage to a third node as a QB node; and an output circuit configured to output the gate low voltage to an output terminal of the stage based on the gate high voltage of the third node or to output the gate high voltage to the output terminal based on the gate high voltage of the second node, wherein the Q-node control circuit includes: a first switching transistor; and a second switching transistor for lowering a voltage between a gate electrode and a source electrode of the first switching transistor included in the Q-node control circuit.

In accordance with some embodiments of the display device, the Q-node control circuit includes different types of switching transistors.

In accordance with some embodiments of the display device, the first switching transistor is a N-type transistor, and the second switching transistor is a P-type transistor.

In accordance with some embodiments of the display device, the gate low voltage is applied to a source electrode and a gate electrode of the second switching transistor, wherein a drain electrode of the second switching transistor is connected to the source electrode of the first switching transistor.

In accordance with some embodiments of the display device, the source electrode of the first switching transistor is connected to a drain electrode of the second switching transistor, wherein the gate electrode of the first switching transistor is connected to the second node, wherein a drain electrode of the first switching transistor is connected to the third node.

In accordance with some embodiments of the display device, a voltage of a fourth node as a Qn node between the source electrode of the first switching transistor and a drain electrode of the second switching transistor is a sum of the gate low voltage and a threshold voltage of the second switching transistor.

In accordance with some embodiments of the display device, when the second node has the gate high voltage, a voltage between the gate electrode and the source electrode of the first switching transistor is a voltage obtained by subtracting the sum of the gate low voltage and the threshold voltage of the second switching transistor from the gate high voltage.

In accordance with some embodiments of the display device, the second switching transistor includes two P-type switching transistors.

In accordance with some embodiments of the display device, gate electrodes of the two P-type switching transistors of the second switching transistor are connected to each other.

In accordance with some embodiments of the display device, a drain electrode of a first P-type switching transistor of the two P-type switching transistors of the second switching transistor is connected to a source electrode of a second P-type switching transistor of the two P-type switching transistors of the second switching transistor, wherein a drain electrode of the second P-type switching transistor of the two P-type switching transistors of the second switching transistor is connected to the source electrode of the first switching transistor.

In accordance with some embodiments of the display device, when the second switching transistor includes the two P-type switching transistors, a voltage of a fourth node as a Qn node between the source electrode of the first switching transistor and a drain electrode of the second switching transistor is a sum of the gate low voltage and respective threshold voltages of the two P-type switching transistors.

In accordance with some embodiments of the display device, when the second node has the gate high voltage, a voltage between the gate electrode and the source electrode of the first switching transistor is a voltage obtained by subtracting the sum of the gate low voltage and the respective threshold voltages of the two P-type switching transistors from the gate high voltage.

As described above, one or more sixth switching transistors T6 for reducing the voltage between the gate electrode and the source electrode of the fifth switching transistor T5 included in the Q-node control unit 720 and 820 are additionally disposed in the stage of the gate driver according to the present disclosure, so that the voltage between the gate electrode and the source electrode of the fifth switching transistor T5 is lowered, thereby reducing power consumption of the display device and reducing the PBTS applied to the fifth switching transistor T5 to secure a desired PBTS margin.

Although some example embodiments of the present disclosure have been described above with reference to the accompanying drawings, the present disclosure may not be limited to these example embodiments and may be implemented in various different forms. Those of ordinary skill in the technical field to which the present disclosure belongs will be able to appreciate that the present disclosure may be implemented in other specific forms without departing from the technical idea, spirit, or features of the present disclosure. Therefore, it should be understood that the example embodiments as described above are not restrictive but are illustrative in all respects.

What is claimed is:

1. A gate driver, comprising:
a plurality of stages selectively connected to lines to which a plurality of clock signals are supplied, and configured to sequentially output a scan signal,
wherein each of the plurality of stages includes:
an input circuit configured to input a gate start signal GVST to a first node as a Q1 node in response to one clock signal;
a Q-node control circuit configured to apply the gate start signal GVST to a second node as a Q node in response a gate low voltage;
a QB-node control circuit configured to apply a gate high voltage to a third node as a QB node in response to a low voltage of the gate start signal GVST; and
an output circuit configured to output the gate low voltage of the second node to an output terminal of the stage based on the gate high voltage of the third node or to output the gate high voltage of the third node to the output terminal based on the gate high voltage of the second node, and
wherein the Q-node control circuit includes:
a first switching transistor; and
a second switching transistor configured to lower a voltage between a gate electrode and a source electrode of the first switching transistor in the Q-node control circuit.

2. The gate driver of claim 1, wherein the Q-node control circuit includes different types of switching transistors.

3. The gate driver of claim 1, wherein the first switching transistor is a N-type transistor, and the second switching transistor is a P-type transistor.

4. The gate driver of claim 1, wherein the gate low voltage is to be applied to a source electrode and a gate electrode of the second switching transistor, and
wherein a drain electrode of the second switching transistor is connected to the source electrode of the first switching transistor.

5. The gate driver of claim 3, wherein the source electrode of the first switching transistor is connected to a drain electrode of the second switching transistor,
wherein the gate electrode of the first switching transistor is connected to the second node, and
wherein a drain electrode of the first switching transistor is connected to the third node.

6. The gate driver of claim 1, wherein a voltage of a fourth node as a Qn node between the source electrode of the first switching transistor and a drain electrode of the second switching transistor is a sum of the gate low voltage and a threshold voltage of the second switching transistor.

7. The gate driver of claim 6, wherein when the second node has the gate high voltage, a voltage between the gate electrode and the source electrode of the first switching transistor is a voltage obtained by subtracting the sum of the gate low voltage and the threshold voltage of the second switching transistor from the gate high voltage.

8. The gate driver of claim 1, wherein the second switching transistor includes two P-type switching transistors.

9. The gate driver of claim 8, wherein when the second switching transistor includes the two P-type switching transistors, the gate electrodes of the two P-type switching transistors of the second switching transistor are connected to each other.

10. The gate driver of claim 8, wherein a drain electrode of a first P-type switching transistor of the two P-type switching transistors of the second switching transistor is connected to a source electrode of a second P-type switching transistor of the two P-type switching transistors of the second switching transistor, and
wherein a drain electrode of the second P-type switching transistor of the two P-type switching transistors of the second switching transistor is connected to the source electrode of the first switching transistor.

11. The gate driver of claim 8, wherein when the second switching transistor includes the two P-type switching transistors, a voltage of a fourth node as a Qn node between the source electrode of the first switching transistor and a drain electrode of the second switching transistor is a sum of the gate low voltage and respective threshold voltages of the two P-type switching transistors.

12. The gate driver of claim 11, wherein when the second node has the gate high voltage, a voltage between the gate electrode and the source electrode of the first switching transistor is a voltage obtained by subtracting the sum of the gate low voltage and the respective threshold voltages of the two P-type switching transistors from the gate high voltage.

13. A display device comprising:
a display panel including a plurality of pixels, each including a plurality of sub-pixels;
a data driver configured to apply a data signal to the display panel; and
a gate driver configured to apply a scan signal to the display panel, wherein the gate driver includes a plurality of stages,
wherein the plurality of stages are selectively connected to lines to which a plurality of clock signals are supplied, and are configured to sequentially output the scan signal,
wherein each of the plurality of stages includes:
an input circuit configured to input a gate start signal GVST to a first node as a Q1 node in response to one clock signal;
a Q-node control circuit configured to apply the gate start signal GVST to a second node as a Q node in response a gate low voltage;
a QB-node control circuit configured to apply a gate high voltage to a third node as a QB node in response to a low voltage of the gate start signal GVST; and
an output circuit configured to output the gate start signal GVST from the second node to an output terminal or output the gate start signal GVST from the third node to the output terminal, and
wherein the Q-node control circuit includes:
a first switching transistor; and
a second switching transistor configured to lower a voltage between a gate electrode and a source electrode of the first switching transistor in the Q-node control circuit.

14. The display device of claim 13, wherein the first switching transistor is a N-type transistor, and the second switching transistor is a P-type transistor.

15. The display device of claim 13, wherein the gate low voltage is to be applied to a source electrode and a gate electrode of the second switching transistor, and
wherein a drain electrode of the second switching transistor is connected to the source electrode of the first switching transistor.

16. The display device of claim 14, wherein the source electrode of the first switching transistor is connected to a drain electrode of the second switching transistor,
wherein the gate electrode of the first switching transistor is connected to the second node, and
wherein a drain electrode of the first switching transistor is connected to the third node.

17. The display device of claim 13, wherein the second switching transistor includes two P-type switching transistors.

18. The display device of claim 17, wherein when the second switching transistor includes the two P-type switching transistors, a voltage of a fourth node as a Qn node between the source electrode of the first switching transistor and a drain electrode of the second switching transistor is a sum of the gate low voltage and respective threshold voltages of the two P-type switching transistors.

19. The display device of claim 18, wherein when the second node has the gate high voltage, a voltage between the gate electrode and the source electrode of the first switching transistor is a voltage obtained by subtracting the sum of the gate low voltage and the respective threshold voltages of the two P-type switching transistors from the gate high voltage.

20. The display device of claim 13, wherein a voltage of a fourth node as a Qn node between the source electrode of the first switching transistor and a drain electrode of the second switching transistor is a sum of the gate low voltage and a threshold voltage of the second switching transistor.

21. The display device of claim 20, wherein when the second node has the gate high voltage, a voltage between the gate electrode and the source electrode of the first switching transistor is a voltage obtained by subtracting the sum of the gate low voltage and the threshold voltage of the second switching transistor from the gate high voltage.
